(19) United States
(12) Patent Application Publication
(10) Pub. No.: US 2024/0413348 A1
(43) Pub. Date: Dec. 12, 2024

(54) DRY-PROCESSED INSULATING FILM FOR ELECTRODE TABS

(71) Applicants: SAFT, LEVALLOIS PERRET (FR); AUTOMOTIVE CELLS COMPANY SE, BRUGES (FR)

(72) Inventors: Evan ADAMCZYK, BORDEAUX (FR); André DE ALMEIDA, BORDEAUX (FR); Julie PERISSÉ, PESSAC (FR)

(73) Assignees: SAFT, LEVALLOIS PERRET (FR); AUTOMOTIVE CELLS COMPANY SE, BRUGES (FR)

(21) Appl. No.: 18/699,823

(22) PCT Filed: Oct. 12, 2022
(86) PCT No.: PCT/EP2022/078417

§ 371 Date: Apr. 9, 2024

(30) Foreign Application Priority Data
Oct. 14, 2021 (FR) FR2110909

(51) Int. Cl. H01M 4/66; H01M 4/02; H01M 4/62; H01M 10/0525

(52) U.S. Cl. CPC H01M 4/664; H01M 4/622; H01M 2004/021; H01M 2004/028; H01M 10/0525

(57) ABSTRACT

The present application relates to an insulating film obtained by dry processing, to a method for obtaining same and to the use thereof to coat electrode tabs, in particular positive electrode tabs for Li-ion batteries.

### CROSS REFERENCE TO RELATED APPLICATION

The present application is a U.S. National Phase Application under 35 U.S.C. § 371 of International Patent Application No. PCT/EP2022/078417 filed Oct. 12, 2022, which claims priority of French Patent Application No. 21 10909 filed Oct. 14, 2021. The entire contents of which are hereby incorporated by reference.

### FIELD OF THE INVENTION

The present invention relates to the field of energy storage, and more specifically to secondary batteries and in particular of lithium type.

### BACKGROUND

Rechargeable lithium-ion secondary batteries offer excellent energy and volumetric densities and currently hold a predominant position on the market for portable electronics, electric and hybrid vehicles, and also for stationary energy storage systems.

The functioning thereof is based on the reversible exchange of the lithium ion between a positive electrode and a negative electrode, separated by an electrolyte.

To limit short circuits at the current collectors, the positive electrode is generally protected by an insulating film.

US 2008/0299461 concerns the prevention of short circuits caused by contacting between the positive and negative electrodes, and describes the application of a ceramic insulating layer on the positive electrode. Nevertheless the ceramic composition is obtained by mixing ceramic powder with a polymer binder in a solvent medium (N-methyl-2-pyrrolidone, NMP). NMP is a toxic solvent and is CMR-classified. In addition, a drying step of the ink is required. This step conducted in an oven consumes much energy and requires major layout in a plant producing Li-ion cells.

The producing of electrode coating via dry process is described for example in US 2015/0061176. However this relates to a cathode foil comprising an active material, and not to coating with a cathode insulating film containing a ceramic.

In the pursuit of obtaining cells without any use of solvent, there remains the need therefore to provide a solvent-free method to obtain an insulating film on positive electrodes in a LI-ion battery.

A first subject of the present invention concerns a method for preparing an insulating film via dry process for the tabs of positive electrode current collectors in a Li-ion cell, said method comprising the steps of:
mixing the ceramic powder and polymer binder,
placing the mixture in film form at a temperature T1, and
adhering the film obtained onto a surface of the tab of the current collector.

The term «insulating» is meant herein to define an electrically insulating nature i.e. the capability of inhibiting the circulation of electric current.

### SUMMARY

The method of the invention allows the providing of an insulating film permitting the limiting of short circuits at the tabs of current collectors of positive electrodes in a Li-ion cell.

The term «tab» used herein defines the portion of the current collector that is not coated with the active material of the electrode. It is generally therefore an «exposed» section of the current collector typically composed of metal foil, such as aluminium foil for example for a current collector tab of a positive electrode. In the invention, a generally «exposed» tab surface is coated with the insulating film.

Said tab comprises an upper surface and a lower surface.

Typically, the film is applied to the surface of the tab intended to lie facing the negative electrode when assembling a Li-ion electrochemical cell.

Therefore, the insulating film is applied to the portion of one and/or the other of the surfaces intended to be in contact with the current collector of the negative electrode or the tab thereof, in the configuration of the electrochemical cell under consideration. Typically, the film is applied onto a portion of the lower surface and a portion of the upper surface.

In one embodiment, for each surface, the insulating film is applied onto a portion located at the end of the tab connected to the collector, on the understanding that at least one portion located at the end of the tab intended to be in contact with the connector is devoid of said film.

Said collector is generally in the form of foil in conductive material such as a metal. Typically the cathodic current collector can be formed of aluminium foil, optionally coated for example carbon coated.

In the invention, said insulating film is composed of a mixture of ceramic powder and polymer binder.

In one embodiment, the ceramic powder represents between 50 and 99%, in particular between 30 and 99% by weight of the ceramic and polymer binder mixture, and the polymer binder represents between 1 and 50%, in particular between 1 and 30% by weight of said mixture.

The quantity of binder can be measured by thermogravimetric analysis for example.

The layer of ceramic coating is obtained by dry process i.e. without the use of solvent.

The method of the invention therefore allows avoiding of the drying step that is generally required in prior art methods.

In one embodiment, the method comprises a step to mix the ceramic powders and polymer binder.

Typically, this mixing step can be performed by jet milling or by shear process for example in an internal mixer or extruder.

In one embodiment, forming is advantageously carried out in an external roller mixer, or in a single or twin-screw extruder.

The forming step allows a homogeneous film to be obtained.

The temperature T1 is generally higher than the melt or softening temperature of said polymer binder.

Typically, the thickness of the film to be obtained can be adjusted according to desired use.

In one embodiment, the mixing step and forming step can be conducted simultaneously or separately.

In one embodiment, the adhering of the film obtained on the tab of the current collector can be obtained by co-lamination on said tab of the current collector. Typically, co-lamination can be performed using a hot press, roller mixer or calender roller for example with hot rollers, and/or in a rolling mill.

In one embodiment, the ceramic powder is chosen from among boehmite, aluminium oxide, magnesium oxide, ATH (AlOH₃) powders, and phosphorus fillers. Typically the ceramic powder can be boehmite of formula AlO(OH).

The term «polymer binder» designates one or more polymers in a mixture, more particularly a mixture of polymers. Said polymers can be chosen from among nitrile rubbers of NBR type (nitrile butadiene rubber) or HNBR type (hydrogenated nitrile butadiene rubber), rubbers of EPDM type (ethylene-propylene-diene monomer), rubbers of EVA type (ethylene-vinyl acetate), elastomers, thermoplastics, polyamides, PVDF and PTFE in particular, alone or in mixtures including mixtures thereof with co-binders.

The method of the invention may also comprise the addition of one or more additives chosen from among crosslinking agents, lubricants, plasticizers, antioxidants, at the mixing step.

A further subject of the invention concerns an insulating film for current collector tab of a positive electrode for a Li-ion cell, comprising a mixture of ceramic and polymer binder free of solvent or traces of solvent, and having porosity of less than 10%, in particular less than 5%.

The present invention therefore also concerns an insulating film for current collector tab of a positive electrode for Li-ion cell able to be obtained with the method of the invention.

In one embodiment, said insulating film has a thickness of between 10 and 100 micrometres (μm).

It has been discovered in the invention that the porosity of the film is related to the type of method used: the low porosity of less than 10%, and in particular less than 5% is characteristic of a preparation method via dry process. A film obtained by wet process effectively has porosity higher than 40%, even in the region of 50 to 60%.

Porosity (as %) can be estimated with the formula:

$$Porosity ( as \% ) = ( 1 - ( {E}_{theoretical} / {E}_{true} ) ) * 100$$

where E_{theoretical} represents the theoretical thickness of the film (for porosity of 0%), able to be calculated from the composition of the coating and grammage (in g/cm²);
and Eₜᵣᵤₑ represents the true thickness.

Alternatively, porosity can also be measured by Hg or He porosimetry.

Advantageously, the low porosity of the film of the invention is also associated with a strong insulating property.

Therefore, for same thickness and similar formulation, the film of the invention exhibits a greater insulating property than that of a film obtained by wet process.

A further subject of the invention concerns a positive electrode having a tab that is at least partly coated by an insulating film of the invention.

An example of a positive electrode A is illustrated in FIG. 5 in which the insulating film 4 of the invention partly covers the tab of the current collector 2 of the positive electrode. The end opposite the current collector intended to be in contact with the connector is devoid of the film 4.

The invention also concerns an electrochemical element of Li-ion type comprising a positive electrode of the invention such as presented in the foregoing.

By «electrochemical element» it is meant an elementary electrochemical cell composed of the assembly of positive electrode/electrolyte/negative electrode, allowing the storing of electrical energy supplied by a chemical reaction and the delivering thereof in the form of a current.

Said electrochemical element is schematically illustrated in particular in FIG. 1.

As illustrated in FIG. 1, the electrochemical element 1 is connected to the external connectors by the tab 2 of the current collector of the positive electrode, and by the tab 3 of the current collector of the negative electrode. Tab 2 is partly coated by the ceramic insulating film 4. The film 4 is present on the tab portion positioned at the end connected to the cathode collector, whilst the opposite end intended to be in contact with the connector is devoid of film.

The electrochemical elements of the invention are preferably secondary batteries having a capacity higher than 100 mAh, typically of 1 to 100 Ah.

A close-up of the arrangement of a tab incorporating the insulating film of the invention is illustrated in FIG. 4.

Within an electrochemical element 1, a positive electrode A and a negative electrode B are separated by a separator C. There is an offset A between the end of the negative electrode B beyond the end of the positive electrode A.

When assembling several elements 1 to form a module, the current collector tabs 2 of the positive electrodes are flexed following the deformation illustrated by the arrow in dotted lines, so that they can be grouped together at the connector. On account of this bending, the tab 2 can be in contact with the separator C and/or with the negative electrode B. The insulating film 4 coating the tab 2 on the surface facing the negative electrode thereby prevents short circuiting.

A further subject of the invention concerns an electrochemical module comprising a stack of one or more elements such as defined above.

Typically, each element is electrically connected with one or more other elements.

The term «module» herein therefore designates the assembly of several electrochemical elements, said assemblies possibly being in series and/or parallel.

One element is illustrated in FIG. 6: in this photograph, positive electrodes A, negative electrodes B and separators C form the central portion.

At one end, the current collector tabs 2 coated with the film 4 are flexed to be grouped together and ensure connection with the connector. The positive tabs are soldered together onto the cap plate of the prismatic casing. The negative tabs, positioned behind the assembly, are not shown in this photograph.

A still further subject of the invention concerns a battery comprising one or more modules of the invention.

By «battery», it is meant the assembly of several modules of the invention.

### BRIEF DESCRIPTION OF THE DRAWINGS

FIG. 1 schematically illustrates a Li-ion electrochemical cell with ceramic insulating film on the positive tab.

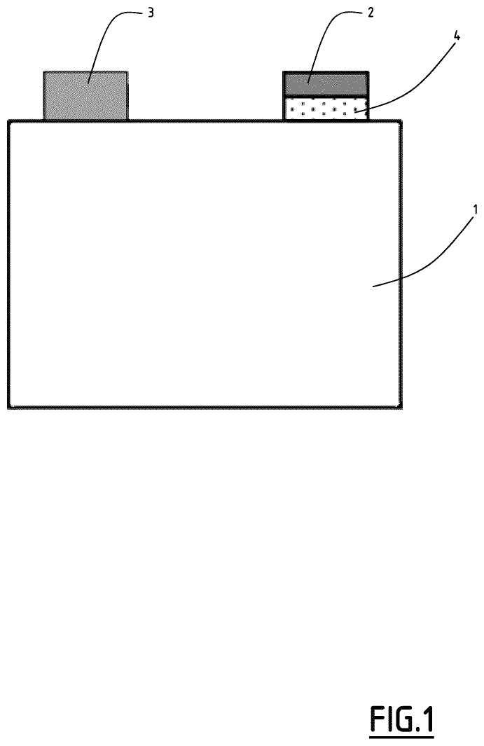

FIG. 2 illustrates the steps of the method for preparing an electrode comprising the film of the invention. 2A: mixing in an internal mixer; 2B: extrusion in single-screw extruder; 2C: co-lamination on carbon-coated foil.

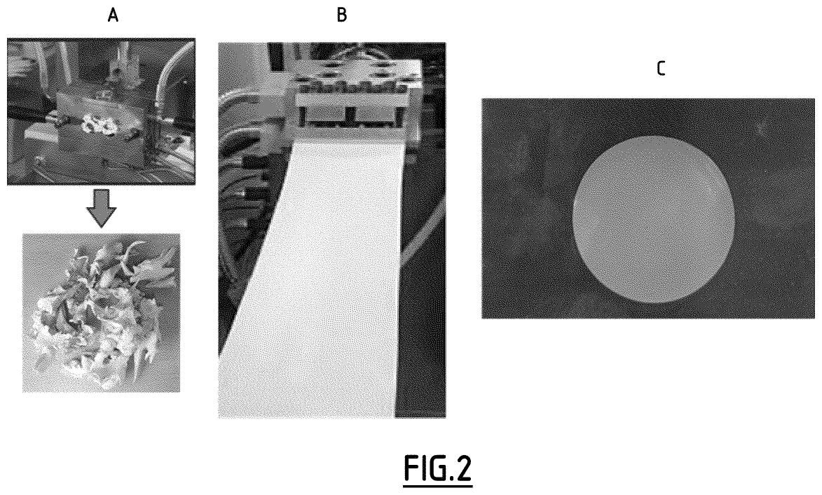

FIG. 3 is a photograph of a dielectric test performed on insulating film. The black dot on the film (identified by dotted circle) is the mark of the dielectric breakdown that occurred on this film.

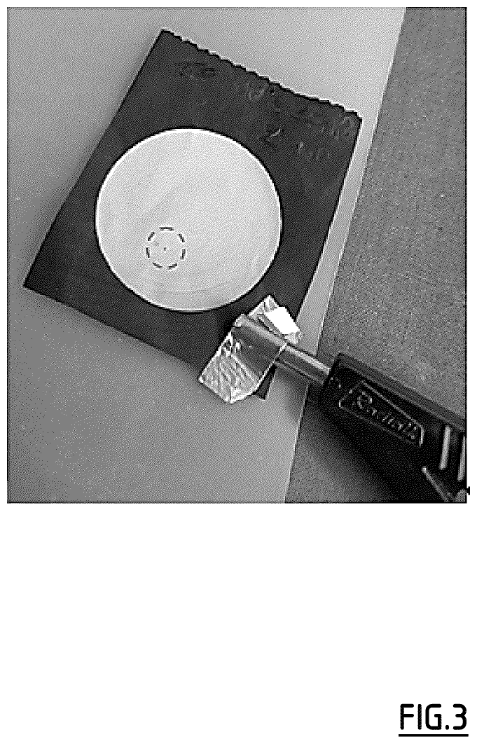

FIG. 4 is a close-up of the respective arrangement of the positive electrode tab of the invention within an electrochemical element.

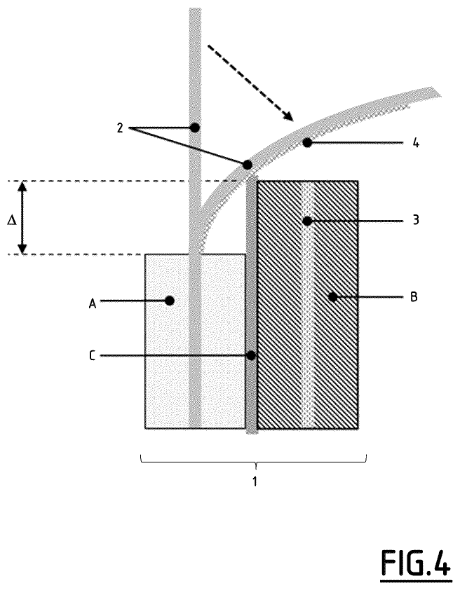

FIG. 5 illustrates the structure of a positive electrode incorporating the tab coated with an insulating film of the invention.

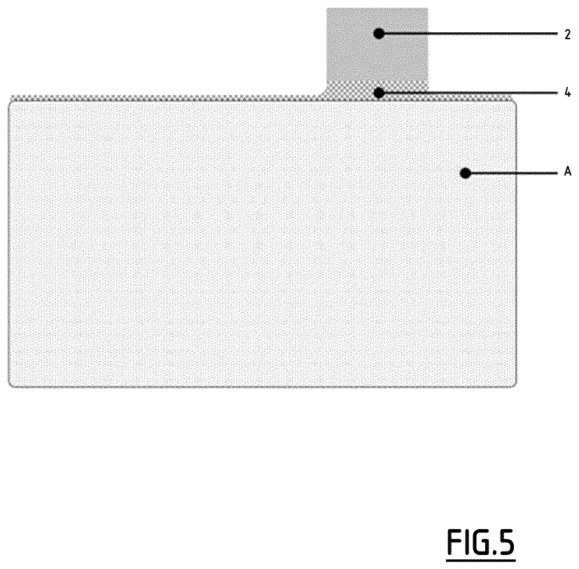

FIG. 6 is a photograph of a cross-sectional cut of the inner structure of an electrochemical element incorporating positive electrode tabs coated with an insulating film of the invention.

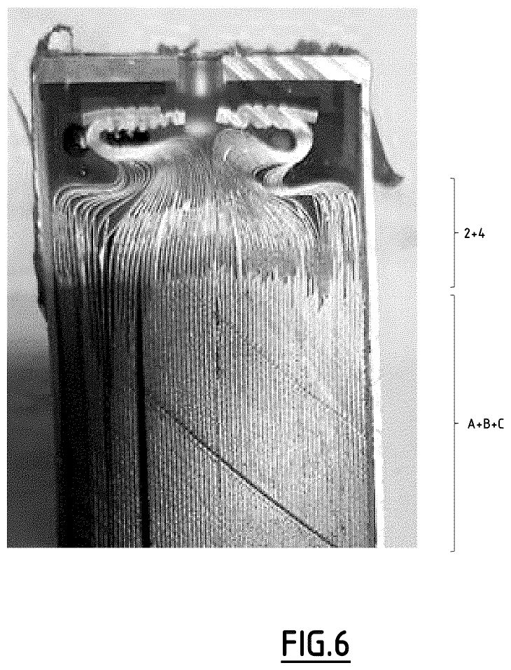

The following examples illustrate the invention but are nonlimiting.

### DETAILED DESCRIPTION

Three formulations of ceramic insulating film were prepared using an internal mixer. The mixing parameters and binder contents are given in Table 1:

TABLE 1
Examples of formulations prepared by solvent-free process

| | | | | Mixing |
|---|---|---|---|---|
| Formulation | Type of | Binder | Temperature of | speed |
| name | binder | content (%) | mixture (° C.) | (rpm) |
| Test 1 | EVA | 30 | 100 | 70 |
| Test 2 | HNBR | 30 | 90 | 50 |
| Test 3 | EPDM | 30 | 110 | 80 |

The temperatures and mixing speed were adapted according to type of binder.

At a first stage, the polymer was added to the internal mixer at the softening or melt temperature thereof. It was mixed alone for 5 minutes until a fluid was obtained. The ceramic fillers (here of boehmite type) were added gradually to prevent a sudden increase in the temperature of the mixture and in machine torque. After complete homogenization, the paste was collected and placed in a single-screw extruder having a fixed flat outlet die of thickness 50 μm. The temperature of the extruder was adapted to the type of binder and modelled on the temperatures of the internal mixer. A continuous strip of ceramic film was collected and caused to adhere to a current collector in Al having on the surface thereof a carbon-type bonding primer. This last step was performed in a hot rolling mill (roller temperature set at 125° C.) where the insulating film and the current collector on which it was laid were co-laminated. Adhesion was obtained through the pressure applied for co-lamination.

The materials obtained were characterized by a breakdown voltage test. A direct current voltage was applied between the upper portion of the film and the current collector. The breakdown voltage is determined on dielectric failure of the insulating film. The higher the breakdown voltage the better the insulation of the film. It is indicated that these tests are conducted at ambient temperature. Irrespective of the ceramic film obtained by dry process, the breakdown voltage was higher (above 1 kV) than that of a film prepared by wet process (about 600 V) at iso-thickness. In addition, differences were also observed with changes in the type of binder of the dry films: 1.1 kV for EVA, 1.5 KV for HNBR and 3.5 kV for EPDM.

The porosity contents of these films were calculated using the formula given above. These contents are 3% for EVA and 5% for EPDM and HNBR.

If these films are prepared via wet process, the porosity thereof is between 45 and 55%.

1. A method via dry process for preparing an insulating film for current collector tab of a positive electrode in a Li-ion cell, said method comprising the steps of:
mixing ceramic powder and polymer binder, and the forming thereof in film form at a temperature T1, and
adhering the film obtained onto a surface of the tab of the current collector.

2. The method according to claim 1, such that the temperature T1 is higher than at least one of a melt or a softening temperature of said polymer binder.

3. The method according to claim 1, such that the mixing step and forming step are conducted at least one of simultaneously or separately.

4. The method according to claim 1, such that the ceramic powder is chosen from among boehmite, aluminium oxide, magnesium oxide, ATH (AlOH₃) powders, and phosphorus fillers.

5. The method according to claim 1, such that the polymer binder is chosen from among nitrile rubbers such as NBR (nitrile butadiene rubber), HNBR (hydrogenated nitrile butadiene rubber); EPDM rubbers (ethylene-propylene-diene monomer); EVAs (ethylene-vinyl acetates), elastomers, thermoplastics, PTFE, PVDF, polyamides, alone or in a mixture.

6. The method according to claim 1, such that the ceramic powder represents between 50 and 99% by weight of the ceramic and polymer binder mixture, and the polymer binder represents between 1 and 50% by weight of said mixture.

7. The method according to claim 1 further comprising adding one or more additives chosen from among crosslinking agents, plasticizers, lubricants, antioxidants, at the mixing step.

8. The method according to claim 1, applying the film onto the surface of the tab intended to face the negative electrode in a Li-ion electrochemical cell.

9. An insulating film for current collector tab of a positive electrode in a Li-ion cell, able to be obtained with the method according to claim 1, and having porosity of less than 10%, in particular less than 5%.

10. The insulating film according to claim 9, such that it has a thickness of between 10 and 100 micrometres (μm).

11. A Li-ion cell comprising a positive electrode current collector having a tab that is at least partly coated with an insulating film according to claim 9.

12. An electrochemical module comprising a stack of one or more cells according to claim 11.
